(19) United States
(12) Patent Application Publication
(10) Pub. No.: US 2025/0298744 A1
(43) Pub. Date: Sep. 25, 2025

(54) Scalable Graph-Based Approach To Accelerating Recommendation Model Inference

(71) Applicant: THE REGENTS OF THE UNIVERSITY OF MICHIGAN, Ann Arbor, MI (US)

(72) Inventors: Haojie YE, Ann Arbor, MI (US); Sanketh VEDULA, Haifa (IL); Alex BRONSTEIN, Haifa (IL); Ronald DRESLINSKI, Ann Arbor, MI (US); Trevor MUDGE, Ann Arbor, MI (US); Nishil TALATI, Ann Arbor, MI (US)

(73) Assignee: THE REGENTS OF THE UNIVERSITY OF MICHIGAN, Ann Arbor, MI (US)

(21) Appl. No.: 18/613,387

(22) Filed: Mar. 22, 2024

(51) Int. Cl. G06F 12/0802; G06N 5/04

(52) U.S. Cl. CPC G06F 12/0802; G06N 5/04; G06F 2212/60

(57) ABSTRACT

The high memory bandwidth demand of sparse embedding layers continues to be a critical challenge in scaling the performance of recommendation models. A lightweight and scalable graph-based algorithm-system co-design framework is proposed to significantly improve the embedding layer performance of recommendation models. This framework includes a novel item co-occurrence graph that scalably records item co-occurrences. Additionally, a new system-aware graph clustering algorithm is presented to find frequently accessed item combinations of arbitrary lengths to compute and memorize their partial sums. High-frequency partial sums are stored in a software-managed cache space to reduce memory traffic and improve the throughput of computing sparse features.

### GOVERNMENT CLAUSE

This invention was made with government support under FA8650-18-2-7864 awarded by the Air Force Research Laboratory. The government has certain rights in the invention.

### FIELD

The present disclosure relates to techniques for processing embedding layers of a model, such as a Deep Learning Recommendation Model.

### BACKGROUND

Deep Learning Recommendation Models (DLRMs) are widely employed to predict rankings of news feeds and entertainment content. An earlier work shows that DLRMs consume a majority of AI inference cycles of data centers. DLRM exhibits a mix of workload characteristics with fully connected dense neural network layers and sparse embedding layers. The sparse embedding layers are the primary performance bottlenecks of DLRM execution due to their high memory bandwidth requirement. Because this application runs at a population scale, the execution bottlenecks significantly increase the Total Cost of Ownership (TCO) and power consumption of data centers. Therefore, improving DLRM performance directly results in saving millions of dollars in cost and carbon emission.

The key challenge in accelerating the DLRM embedding layer performance is to exploit spatial and temporal locality. This challenge is because of the irregular nature of the workload's memory access pattern over large embedding tables. Recently, several techniques have attempted to improve the DLRM embedding layer inference performance either by caching partial sums of embeddings leading to reduced memory traffic or by exploiting the heterogeneous memory systems. These approaches, however, fall short in the following manner. First, FAE and Rec-NMP employ heterogeneous memory systems to exploit the power-law in the item access frequency distribution; however, they do not improve the memory traffic. Second, SPACE employs a heuristic threshold to select a small subset of popular items and stores exhaustive combinations of two-item partial sums that leads to low memory bandwidth reduction. Third, MERCI employs an expensive user trace processing technique to store partial sums of more than two items. It has three main drawbacks: (i) the algorithm does not scale to large embedding tables, (ii) the algorithm operates on the level of sub-groups of embeddings and it does not capture a global view of user-item interactions; thus the resulting partial sum formation is based on a limited scope of user-item interactions, leading to sub-optimal memory traffic reduction, and (iii) its design is unaware of memory heterogeneity. An ideal design goal is to significantly reduce memory traffic while exploiting memory heterogeneity in a scalable fashion.

This disclosure presents a scalable graph-based algorithm system co-design (referred to herein as GRACE) that significantly improves the memory system performance of DLRM embedding reduction on commodity hardware. Due to the software-only nature of its design, GRACE can be immediately deployable in today's data centers.

This section provides background information related to the present disclosure which is not necessarily prior art.

### SUMMARY

This section provides a general summary of the disclosure, and is not a comprehensive disclosure of its full scope or all of its features.

A computer-implemented method is presented for processing embedding layers of a model. The method includes: receiving a historical data set of items accessed by users of a computer system, where each entry in the historical data set indicates a subset of items accessed by a given user; constructing a graph from the historical data set, where a node in the graph represents a given item, an edge between nodes represents an occurrence of the items being accessed together, and a weight assigned to an edge in the graph indicates a frequency of the items being accessed together; clustering nodes in the graph to form one or more clusters of nodes; for each cluster in the one or more cluster of nodes, computing partial sums for the nodes assigned to a given cluster; and storing the partial sums in a cache memory.

During runtime, a list of items a particular user has shown an interest in is received. For each item on the list of items, a unique identifier for the cluster containing the item is determined using a remapping table; and partial sums for the item are retrieved from either the cache memory or the non-cache memory. A reduction for items in the list of items is then performed using the retrieved partial sums.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a diagram depicting a heterogeneous CPU-GPU system executing DLRM inference.

FIG. 1B is a diagram showing the workflow of a DLRM inference execution with a heterogenous CPU-GPU system.

FIG. 2 is a flowchart depicting an overview for a method for processing embedding layers of a model.

FIG. 3 is a flowchart depicting an example of how to cluster nodes in the graph.

FIG. 4 is a flowchart depicting an example of how to form a cluster.

FIG. 5 is a flowchart depicting steps for accessing the improved memory layout.

FIGS. 6A-6C is an example demonstrating the cost-benefit model of adding a node to an existing cluster.

FIG. 7 illustrates an example of the clustering technique.

FIG. 8 is a graph showing clustering time comparisons of GRACE and MERCI using a 128-thread implementation amongst different datasets.

FIG. 9 illustrates a usage mode of GRACE.

FIGS. 10A-10C are diagrams further illustrating how partial sums are stored in memory.

FIG. 11 is a diagram showing an example cache space layout and address generation.

Corresponding reference numerals indicate corresponding parts throughout the several views of the drawings.

### DETAILED DESCRIPTION

Example embodiments will now be described more fully with reference to the accompanying drawings.

By way of background, the goal of Deep Learning Recommendation Models (DLRM) is to predict the Click-Through Rate (CTR), i.e., the probability of a user clicking on an advertised item. A major data center operator Meta (previously Facebook) has claimed that DLRM models consume more than 60% of their AI inference cycles in production, which makes them a leading candidate for optimization. In contrast to traditional deep neural network (DNN) models, DLRM features a hybrid architecture of multi-layer perceptron (MLP) models and embedding layers. The “dense” input features (e.g., age, gender, and location of the user) are processed by the first MLP to generate dense features. The sparse input features (e.g., previous user-item interactions), on the other hand, are processed by the embedding layers. An embedding layer contains a large embedding table that stores feature vectors of different items. A user's past interactions with items are used to index these tables to extract items' features. These features are then reduced to represent the summary of the user's interests. This layer performs sparse computation because a user only interacts with a handful of items out of millions of available items. These sparse and dense features are thereafter concatenated and fed into another MLP layer to predict the CTR.

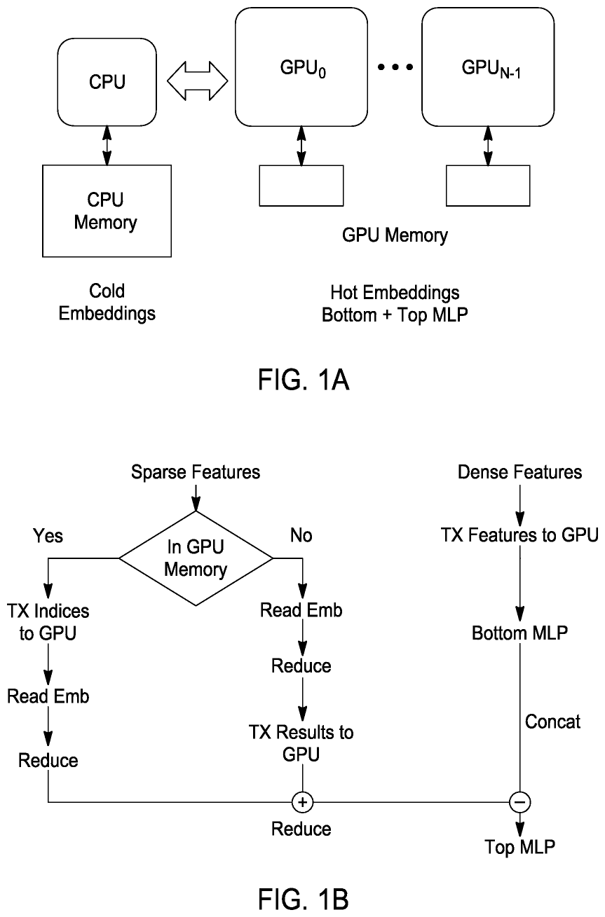

DLRM systems in production employ a hybrid CPU-GPU design to execute MLPs and memory-bandwidth-demanding embedding layers in DLRM models. A simplified depiction of executing DLRM models on a hybrid CPU-GPU system is presented in FIG. 1A. GPU executes MLPs to exploit higher compute throughput. The high-bandwidth GPU memory is used to handle the memory bandwidth-intensive reduction operations of the embedding layers. However, the embedding tables that store all item features can amount from tens of GBs to TBs, making it impossible to fit the entire table into GPU memory. Thus, the GPU memory acts as a software-managed cache space to store a portion of the embedding tables. Low-bandwidth CPU memory with high capacity is employed to store and reduce the rest of the embedding entries that do not fit in the GPU. FIG. 1B further shows the state-of-the-art DLRM inference framework that incorporates a GPU. After receiving a batch of user requests, the requested embedding indices are transferred (TX) to the GPU and are evaluated for whether each of them is on CPU or GPU. The embedding reduction operations will distribute to the corresponding memory and CPU/GPU reduces the embeddings to produce the results for each user before the results are finalized on GPU for top MLP layers.

Real-world DLRM inputs follow a power-law distribution, where a small collection of popular items accounts for a large fraction of embedding table accesses. Prior works that exploit power-law distribution for optimization are summarized below. FAE proposes a framework that constructs an empirical distribution of item access frequencies by profiling a portion of the user-item access trace. The framework then calibrates a popularity threshold and uses the GPU memory to store the highly accessed embeddings. RecNMP proposes a small cache structure to each rank level near-memory processing module to bypass the DRAM loads of frequently accessed items. SPACE employs a hybrid memory architecture with HBM and DIMM, where HBM stores popular user choices. SPACE introduces two new concepts called gather locality and reduction locality. The power-law nature of the item access frequencies implies that preferential treatment of popular items (i.e., placing them in HBM) can promote gather locality. Reduction locality, on the other hand, is availed by storing partial reductions of any two popular item vectors. Specifically, SPACE uses psum2, i.e., reduction of embedding vectors of pairs of popular items. To exploit these two types of locality, SPACE pre-processes the user-item access trace to extract popular item choices and their combinations. These popular embedding vectors are stored in capacity-limited HBM that enables high-bandwidth access, while other embedding vectors are extracted from DIMMs. MERCI generalizes SPACE by storing partial sums of more than two items. MERCI inspects the user-item interaction trace, analyzes popular co-accessed items, and merges them into clusters. Within the cluster, all partial sums are stored using the additional DRAM storage.

The recent development of DLRM observes a super-linear growth of capacity and bandwidth demands. The evolution in DLRM has resulted in much richer embedding features, leading to increased data volumes. The memory footprint of DLRM has increased by 16 times, reaching an order of terabytes within four years. Additionally, the inherently irregular nature of memory accesses over large embedding tables results in a significant portion of accesses that cannot be served using capacity-limited caches, increasing the off-chip memory bandwidth requirements. The bandwidth demand of DLRM embedding layers has increased by 30 times to 2 TB/s, dramatically outpacing the bandwidth growth of accelerator memories and interconnections.

Today's DLRM models involve several million items accessed by tens of millions of users. Scalably identifying frequently accessed item combinations that result in an effective memory traffic reduction remains a major challenge. Additionally, prior works do not systematically optimize for a collective bandwidth reduction of the heterogeneous memory system, resulting in a memory throughput imbalance.

A scalable graph-based algorithm system (GRACE) is presented to to tackle the aforementioned challenges. The framework designs the content of the capacity-limited cache space to maximize the DLRM inference performance. The designed cache space can contain both popular item embeddings and partial sums of item combinations of arbitrary lengths.

The goal of the GRACE algorithmic framework is to make the most efficient use of the cache space to store frequently accessed items and their combinations, given the capacity limitation. In particular, the algorithmic framework must meet the following expectations.

No exhaustive caching—storing all pairs of highly accessed items leads to an space complexity, where n is the number of highly accessed cached items. In this setting, it is not guaranteed for all of the two frequently accessed items to be frequently co-accessed; caching partial sums of rarely co-accessed items wastes cache space. Thus, the algorithm must not exhaustively cache all the possible partial sums of highly accessed items.

Scalable with trace size—the algorithm to build the cache space must have low complexity. In practice, the user-item interaction trace size can grow infinitely, and the number of users and items can scale to many millions. Therefore, a high-complexity algorithm to find popular partial sums to cache can lead to prohibitive analysis times.

System awareness—the algorithm should account for different dataset characteristics and underlying system configurations, and be extensible to multiple embedding tables to achieve optimal performance in realistic deployment environments.

Given the user-item interaction trace, the goal of the algorithm is to find the most frequently accessed items and item combinations. Naively counting frequencies of all item combinations results in a combinatorial explosion, thus it is not feasible even for a small number of item combinations. To tackle this problem, the notion of an Item Co-occurrence Graph (ICG) is introduced. In an ICG, the nodes represent items accessed by users of a computer system, edges between nodes represent an occurrence of items being accessed together, and edge weights represent the frequency of co-occurrence of items across the sampled user access patterns (i.e., frequency of the items being accessed together). The problem of scalably tracking frequencies of arbitrary-sized item combinations is cast as a graph problem on the ICG. The user-item interaction trace can have different orders of items being accessed (i.e., irregular accesses) by users, and the trace size can grow infinitely. Key advantages of representing user item interaction trace via ICG are (i) the graph size is invariant to the number of users, (ii) it is an order-agnostic representation of user-item trace, and (iii) the number of nodes in the graph grows only linearly in the number of items. Heavily weighted edges in the ICG efficiently capture highly co-accessed combinations of items gathered from all user-item interactions. Thus, ICG provides a succinct global view over the user-item interaction trace, and allows for the design of efficient graph analysis algorithms that scale to large numbers of users and items.

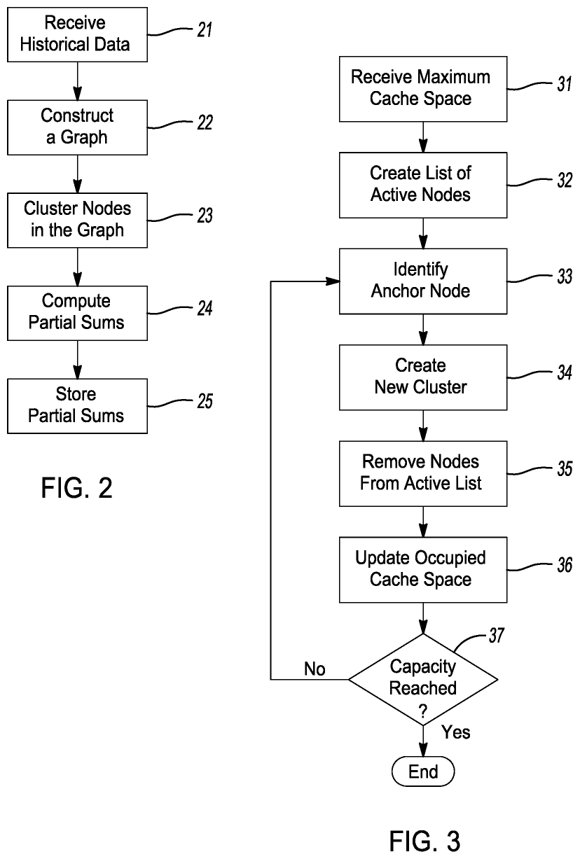

FIG. 2 provides an overview for a method for processing embedding layers of a model, such as a Deep Learning Recommendation Model. To identify frequently accessed items, an Item Co-occurrence graph is first constructed. To do so, a historical data set of items access by users is received at 21, where each entry in the historical data set indicates a subset of items accessed by a given user. A graph is then constructed from the historical data set as indicated at 22. As noted above, a node in the graph represents a given item, an edge between nodes represents an occurrence of the items being accessed together, and a weight assigned to an edge in the graph indicates a frequency of the items being accessed together.

In an example embodiment, pseudo-code for constructing a graph is set forth in Algorithm 4 below.

| 1: procedure BuildICG(user_accesses) | |
|---|---|
| 2: | Input: user_accesses: Historical data of item accesses by |
| | sampled users |
| 3: | Output: G: Item co-occurrence graph (ICG) |
| 4: | |
| 5: | recorded_edges = [ ] |
| 6: | for all user_access ∈ user_accesses do |
| 7: | num_items = user_access.size( ) |
| 8: | // For each user access, iterate over all unique item pairs |
| 9: | for i in (0, num_items) do |
| 10: | for j in (i + 1, num_items) do |
| 11: | item_i = user_access[i]; item_j = user_access[j]; |
| 12: | // Lazy buffering of graph edges |
| 13: | recorded_edges.append(edge(item_i, item_j)) |
| 14: | |
| 15: | Initialize empty graph G |
| 16: | for edge in recorded_edges do |
| 17: | if edge not in G then |
| 18: | G.add_weighted_edge(edge, 0) |
| 19: | G.increment_edge_weight(edge) |
| 20: | return G |

To build the graph, first randomly sample users. For each sampled user, buffer all pairs of items accessed by the user as item co-occurrences. Next, use this item co-occurrence buffer to construct a weighted graph by increasing the edge-weight by one for each co-occurrence. The buffer of edges/item co-occurrences can be constructed online by a fire-and-forget process without impacting the performance of ongoing DLRM inference; the weighted graph is constructed offline during the cache design phase.

Returning to FIG. 2, the nodes in the graph are clustered at 23 to form one or more clusters of nodes. The goal of the clustering phase is to identify frequently occurring item combinations from the user access patterns. Post clustering, the nodes (items) from the same cluster are deemed to be accessed together frequently. One way to cluster the graphs is by employing off-the-shelf graph clustering algorithms, such as Metis. Notably, these clustering algorithms optimize for different criteria and do not create clusters that minimize DLRM bandwidth.

Here, a novel clustering algorithm is proposed that clusters the graph with the objective of maximizing bandwidth reduction in the DLRM. The proposed algorithm is caching space-aware, i.e., it also accounts for capacity-limited cache space for clustering decisions. Post clustering, the partial sums of embeddings of all item combinations within each cluster as stored in cache memory as indicated at 25. During inference, these cached partial sums are used to (i) reduce memory traffic, and (ii) avail efficient memory accesses to increase end-to-end DLRM throughput.

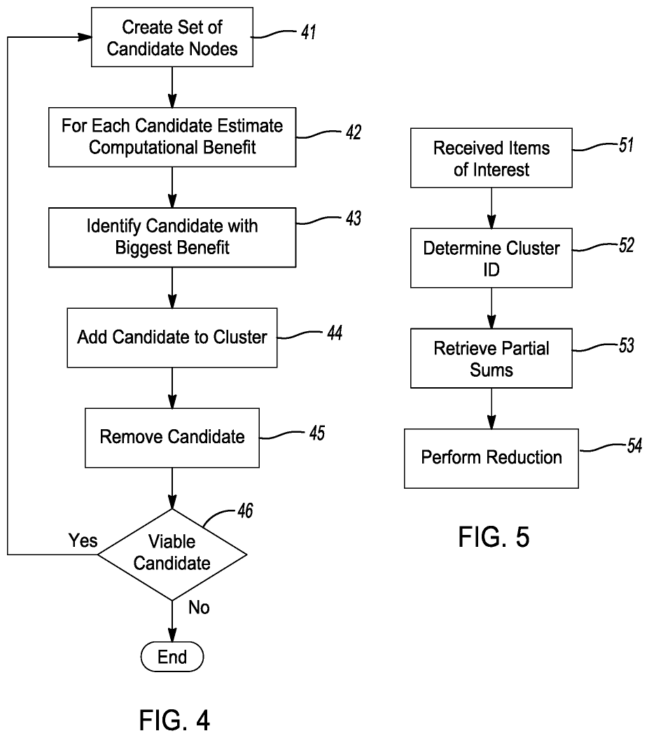

FIGS. 3 and 4 further depict the clustering technique. The proposed algorithm uses a greedy approach to form the clusters. The inputs to the clustering algorithm are: (i) the item co-occurrence graph; (ii) a sorted list of active nodes, where nodes are sorted by their degrees in the graph; and (iii) a capacity budget denoting the number of lines of item embeddings/psums allowed in the cache space (i.e., a maximum value for the cache).

As a starting point, an anchor node is identified at 33 from amongst the nodes in the list of active nodes, where the anchor node forms a new cluster. The anchor node has the largest sum of weights for edges connected thereto amongst the nodes in the list of active nodes. A new cluster is created at 34 using the anchor node as will be further described below in relation to FIG. 4. Once a new cluster is formed, nodes forming the new cluster are removed from the list of active nodes as indicated at 35. Additionally, the memory space allocated to the clusters is updated at 36 with occupied memory space of the new cluster. In one example, the memory space occupied by the newly formed clusters is computed as occupied_space=occupied_space+2^{cluster_size}−1−cluster_size, where cluster_size is the occupied memory space of the new cluster. These steps are repeated as indicated at 37 until the memory space occupied by the newly formed clusters reaches the maximum value of the cache memory.

Algorithm 1 sets forth pseudocode for an example implementation of the clustering method.

1: procedure ClusterICG( )

| 2: | Input: G: Item Co-occurrence Graph (ICG) | |
|---|---|---|
| 3: | Input: nodes: Vertex set of G sorted by their degrees | |
| 4: | Input: capacity_budget: Number of cache lines allowed in | |
| | cache space | |
| 5: | Output: cluster_list: Assignment of ICG nodes into | |
| | different clusters | |
| 6: | | |
| 7: | node_idx=0; cluster_id=0; occupied_space=\|nodes\| | |
| 8: | active_list[u]=0, ∀ u ∈ nodes | [symbol] indicator whether a |
| | | node is clustered |
| 9: | while node_idx < \|nodes\| do | |
| 10: | anchor_node = nodes[node_idx] | |
| 11: | remaining_memory = capacity_budget − occupied_space | |
| 12: | // Create a cluster using an anchor node | |
| 13: | cluster = FormCluster(G, anchor_node, active_list, | |
| 14: | remaining_memory) | |
| 15: | // Calculate occupied space, break if OOM | |
| 16: | occupied_space += 2^{cluster.size( )} − 1 − cluster.size( ) | |
| 17: | if occupied_space >= capacity_budget then | |
| 18: | break | |
| 19: | cluster_list[cluster_id] = cluster | |
| 20: | cluster_id += 1 | |
| 21: | while !active_list[nodes[node_idx]] do | |
| 22: | node_idx += 1 | [symbol] increment until the |
| | | first active node |

| | |
|---|---|
| 23: | return cluster_list |

A list of active nodes that are not clustered is maintained and this list is updated as the algorithm progresses. The algorithm loops over all active nodes and attempts to greedily form new clusters. Within each loop, the largest degree vertex that is active is chosen as an anchor node and is passed to FormCluster( ) to form a cluster of an arbitrary size. Upon forming a cluster, occupied_space is updated. For each cluster, the algorithm saves all combinations of its constituent items, taking an additional size of 2^{cluster_size}−1−cluster_size compared to originally stored item embeddings. The algorithm terminates when the occupied_space reaches the capacity budget or allocation for the cache memory.

Turning to FIG. 4, the method for creating a new cluster is described. Given an anchor node, a set of candidate nodes is created at 41, where the candidate nodes in the set of candidate nodes are neighboring nodes to the anchor node. For each candidate node in the set of candidate nodes, estimating a computational benefit at 42 of adding a given candidate node to the new cluster to form a candidate cluster. Next, identify a particular candidate node from the candidate nodes in the set of candidate nodes as indicated at 43, where the particular candidate node has largest computational benefit from amongst the candidate nodes in the set of candidate nodes. The particular candidate node is in turn added at 44 to the new cluster based on the computational benefit of adding the particular candidate node to the new cluster. The particular candidate node is also removed at 45 from the set of candidate nodes. In one embodiment, this process is repeated as indicated at 46 until no viable candidate nodes remain in the set of candidate nodes. In other embodiments, the process is repeated until no viable candidate nodes remain in the set of candidate nodes, the new cluster exceeds a maximum cluster limit, or the newly formed clusters reach the maximum value of the cache memory.

Algorithm 2 presents the pseudocode for forming individual clusters.

1: procedure FormCluster(g, anchor_node, active_list)

| | |
|---|---|
| 2: | Input: G: Item co-occurrence graph (ICG) |
| 3: | Input: anchor_node: The node selected to create the cluster |
| 4: | Input: active_list: List of unclustered nodes |
| 5: | Input: remaining_capacity: Remaining memory within the |
| | cache space |
| 6: | Output: cluster: Formed cluster containing anchor_node |
| 7: | Constant: MAX_CLUSTER_SIZE: Maximum size of any cluster |
| 8: | |
| 9: | candidates = {anchor_node} |
| 10: | best_candidate = anchor_node |
| 11: | current_benefit = 0 |
| 12: | while true do |
| 13: | cluster.append(best_candidate) |
| 14: | candidates.remove(best_candidate) |
| 15: | active_list.erase(best_candidate) |
| 16: | // Potential candidates while inducting the next node into cluster |
| 17: | candidates.add(active_list ∩ neigh(best_candidate)) |
| 18: | best_candidate = −1 |
| 19: | current_benefit *= tolerance_factor |
| 20: | if cluster.size( ) >= MAX_CLUSTER_SIZE then |
| 21: | break |
| 22: | if 2^{cluster.size( )} + 1 − 1 >= remaining_memory then |
| 23: | break |
| 24: | for all candidate ∈ candidates do |
| 25: | // Estimate benefit of adding the candidate to the cluster |
| 26: | est_benefit = EstimateBenefit(G, cluster, candidate) |
| 27: | if est_benefit > current_benefit then |
| 28: | current_benefit = est_benefit |
| 29: | best_candidate = candidate |
| 30: | if best_candidate < 0 then |
| 31: | return cluster |
| 32: | return cluster |

In this implementation, the FormCluster( ) function receives four inputs: (a) the graph; (b) the anchor node; (c) the list of active nodes that are not yet clustered; and (d) remaining cache capacity. Given an anchor node, all its neighbors that are part of the active list become the candidates to be added to the cluster. A cost-benefit model is used to estimate the cost efficiency obtained by including a new node in the cluster. To select the best candidate to add to the existing cluster, the estimated benefit of adding each of the candidates to the cluster is calculated, and the node that yields the maximum expected benefit is added to the cluster. This algorithm is greedy because it chooses the next best node from the candidate set to insert into the clusters. When a new node is admitted to the cluster, it is removed from the candidate set and the active list.

For the next iteration, the candidate set is updated to contain the neighbors of all the nodes in the cluster so far that are in the active list. In each round, after determining a new node to join the cluster, the total estimated benefit is recorded. When new candidates are evaluated, they are deemed valid to join the cluster if the cost efficiency yielded by their addition to the cluster is greater than the previous cost efficiency (within a specified tolerance level). This procedure terminates when one of the following criteria is satisfied: (i) no valid candidates are found to add to the cluster based on the estimated benefits; (ii) the cluster size exceeds a maximum cluster limit imposed externally; (iii) the cluster exceeds the total memory budget in the cache space. Finally, the formed cluster is returned.

The goal of the cost benefit model is to estimate the benefit of admitting a candidate node into a given cluster. Measuring the exact benefit of adding a node to a cluster of items requires going over the entire trace of user accesses to measure the frequency of all subsets of items. The resulting complexity would be exponential with the size of the cluster. Therefore, it is prohibitively expensive and unrealistic even for small datasets. The key idea of this approach is to exploit the item co-occurrence graphs to estimate the expected savings of a cluster without explicitly counting the frequency of all combinations. The proposed estimate relies on inclusion-exclusion rules in combinatorics. This allows one to build lower and upper bounds on the frequency of larger tuples (triplets, quadruplets, and beyond) by only measuring the frequency of pairs (i.e. the number of co-occurrences). These lower and upper bounds on frequencies directly allow one to estimate the lower and upper bounds of the expected bandwidth reduction resulting from caching all subsets of a given cluster.

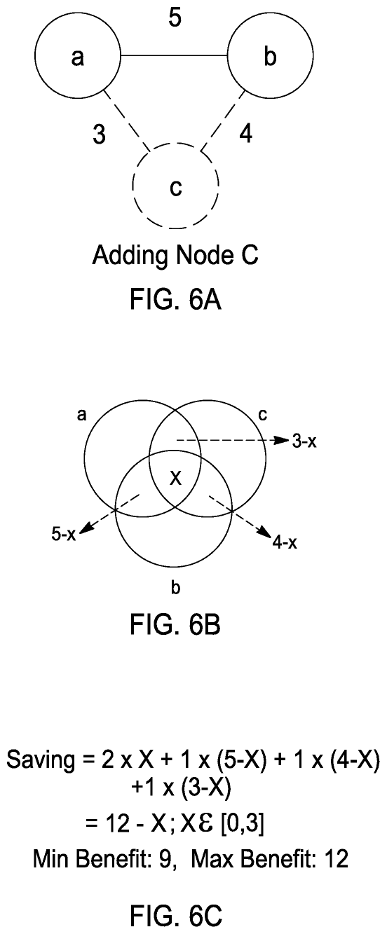

With reference to FIGS. 6A-6C, an intuitive explanation of the cost-benefit estimation is explained. Suppose one is provided with a cluster that already contains items a and b, and the goal is to estimate the benefit of adding item c to the cluster. As depicted in FIG. 6A, suppose items a and b are co-accessed 5 times, items b and c are co-accessed 4 times, and items a and c are co-accessed 3 times. However, note that the graph, since it encodes only pairwise relations, does not offer any information on how often all three items are accessed together. This information can be represented in the form of a Venn diagram where (a, b), (b, c), and (c, a) correspond to different sets as depicted in FIG. 6B. Assume that the intersection of three sets has x elements. Storing the partial sum of a, b & c, denoted by psum(a, b, c), reduces the number of embedding fetches from 3 to 1 when all these items are accessed together. Storing the partial sums of pairs, on the other hand, would save one embedding fetch if the pair is co-accessed. Based on this knowledge, one can calculate the total savings of caching all pairs and the triplet as shown in FIG. 6C as a function of x. Given the number of co-accesses between (a, b)=5, (b, c)=4, and (c, a)=3, the maximum frequency of (a, b, c) could be 3 and the minimum frequency of (a, b, c) could be 0. Therefore, caching all combinations of a, b, and c yields worst-case and best-case savings of 9 and 12, respectively.

Forming a cluster with nodes a, b, and c implies that caching these embeddings and their partial sums: emb(a), emb(b), emb(c), and additionally psum(a, b), psum(b, c), psum(a, c), and psum(a, b, c), i.e., four additional cached partial sums. Consequently, the cost benefit model estimates the maximum and minimum benefit of adding a node c to the cluster of nodes a and b would be 9/4 (min_expected_saving in Algorithm 3) and 12/4 (max_expected_saving in Algorithm 3). In practice, observe that the exact benefit of adding a node to a cluster is around the midpoint of the maximum and minimum estimated benefits.

In one example embodiment, a computation benefit of adding a candidate node to a new cluster is determined as follows. A maximum benefit of adding a given candidate node to the new cluster is estimated by summing weights of edges in the candidate cluster and a minimum benefit of adding a given candidate node to the new cluster is estimated by subtracting weight of edge having lowest value in the candidate cluster from weight of edge having highest value in the candidate cluster. The computational benefit of adding a given candidate node is then set to a midpoint between the minimum benefit and the maximum benefit. Other techniques for estimating the computational benefit also fall within the scope of this disclosure.

Algorithm 3 sets forth pseudocode for estimating the cost benefit of adding a candidate node to a cluster.

1: procedure EstimateBenefit(G, cluster, candidate)
2: Input: G: Item co-occurrence graph (ICG)
3: Input: cluster: the current formed cluster so far
4: Input: candidate: candidate node to join cluster
5: Output: est_benefit: estimated savings per cache line
6:
7: g = subgraph(G, cluster)
8: // Construct g′, the resulting cluster if candidate was added to g
9: g′ = g.add_node(G, candidate)
10: // Estimate cost benefit by the creation of g′
11: lower_bound = min_expected_saving(g′)
12: upper_bound = max_expected_saving(g′)
13: // g′ is the resulting cluster if candidate was added, thus |g′| ≥ 2
14: $est\_benefit = \frac{( 1 - α ) \times lower\_bound + α \times upper\_bound}{2 ( \vert {g}^{′} \vert - 1 - \vert {g}^{′} \vert )}$
15: return est_benefit

A linear interpolation factor α between the lower and upper bounds of the benefit is used to estimate the cost efficiency of the proposed cluster as shown above.

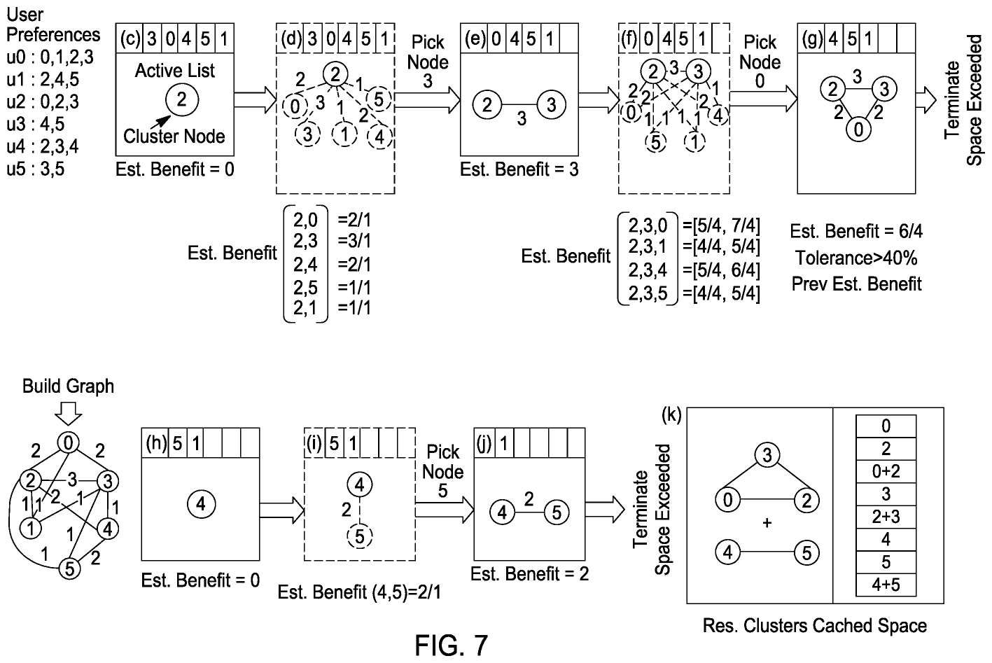

To best understand the proposed algorithms, FIG. 7 shows a walkthrough example of graph building and clustering. User-item interaction traces are shown at top left, where 5 different users are accessing unique items. In this example, the maximum cache capacity is set to 10 cached items with a tolerance factor set to 0.4, and a set to 0.5. Note that the proposed algorithms are not restricted to these parameters and can work for any parameter setting, these parameters are chosen for simplicity.

The graph that is formed as a result of shown user preference trace is shown at bottom left of FIG. 7. In this example, the node IDs correspond to items from 0 to 5. The edge weights of the graph represent the number of times items corresponding to its source and destination nodes are co-accessed. For example, items 2 and 3 are co-accessed by three users, i.e., users 0, 2, and 4, hence, a weight of 3 is assigned to the edge between nodes 2 and 3.

Node clustering starts by assigning all nodes to the active list, and picking the first node to start forming clusters. Because node 2 has the highest degree (i.e., item 2 is the most popular), the first node that starts building clusters is node 2. Based on line 24 of Algorithm 2, all the neighbors of node 2 from the active list are picked to estimate the benefit-per-cached-space of adding them to an existing cluster. Based on graph connectivity, node 3 has the best estimated benefit of 3/1 for getting added to the cluster. Therefore, the clustering algorithm picks node 3, and forms a cluster of nodes 2 and 3. Note that this cluster takes 3 cache spaces, which is less than the cache budget of 10. Therefore, this algorithm continues and it attempts to find new nodes to add to the same cluster.

Cluster expansion continues by examining the neighbors of nodes 2 and 3 to the existing cluster. Using nodes 0, 1, 4, and 5, the algorithm calculates the cost of adding each of these nodes to an existing cluster of nodes 2 and 3. FIG. 7 shows the range of benefits calculated by the algorithm, and using an α of 0.5, node 0 has the highest estimated benefit of 6/4 (the denominator of 4 is because the cluster of three nodes would consume 4 additional caching locations). Because this benefit is within a tolerance limit of the previously estimated benefit (i.e., 6/4>0.4×3), node 0 is added to the cluster. At this point, 7 out of 10 cache spaces are claimed, and adding any more nodes to the cluster would result in more than 10 cache spaces. Therefore, this clustering algorithm terminates, and it picks up a new node 4 from the active list to form a fresh cluster. The result of this iteration of clustering is a 2-node cluster with nodes 4 and 5.

The result of this clustering algorithm is shown at the bottom right of FIG. 7, where two clusters are formed with 2 and 3 nodes. It also shows the consumption of cache space taken by these two clusters. Here, 0+2 means the partial sum of items 0 and 2. Of note are two important details: (i) clusters can be of different sizes (size of 2 and 3 in this example); (ii) the partial sums of all combinations of items in a cluster are cached. The cache layout is carefully tailored to compute addresses easily as discussed below. In practice, the cache space budget is much higher, and this algorithm forms several clusters of different sizes.

For overhead analysis, denote the number of users by m, and the average length of item interactions per user by p. The complexity of graph construction (Algorithm 4) is O (mp²). Let n be the number of nodes (items) in the graph, d be the average degree per node, and k be the average size of a cluster. The complexity of a single evaluation of the cost model is O (k²). In Algorithm 2, the while (true) loop is iterated k times; each iteration makes d calls to the EstimateBenefit( ) function (Algorithm 3). Therefore the overall complexity of FormCluster( ) is O (dk³), executed n/k times. Thus, the overall complexity of clustering the graph is O (ndk³).

The graph construction phase is linear in the number of users; whereas, the clustering phase is linear in the number of items. This allows the proposed algorithm to scale to a large number of users and items. The graph clustering complexity is quadratic to k. An evaluation shows that k goes up to 8 for the best DLRM performance, making the clustering algorithm practical.

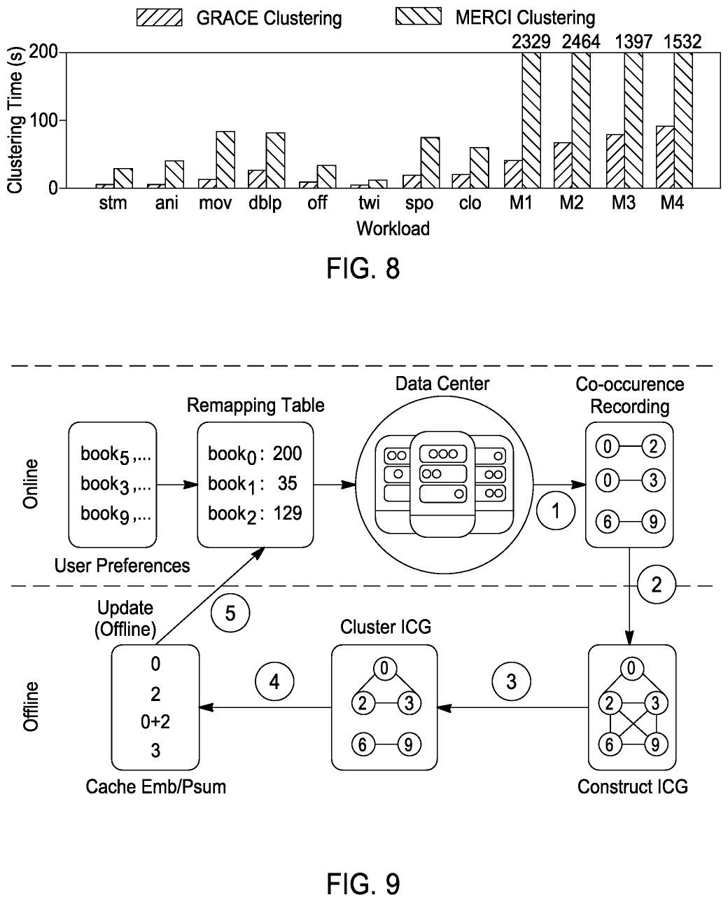

To evaluate the runtime overhead of clustering algorithm, a parallel version of this algorithm is implemented in C++ using OpenMP. To best match the estimation to a data center deployment scenario, this clustering algorithm is run on a high-end server-grade CPU discussed below. Using a 128-thread implementation, FIG. 8 compares the clustering speeds of GRACE and MERCI. GRACE achieves 8.3× faster clustering on average among all datasets, and 26.6× among the mixed datasets that have a larger number of items. This shows that the GRACE algorithmic framework meets one of its key goals, i.e., designing a practical and scalable algorithm. With the low-cost scalable clustering algorithm, GRACE can adapt to frequent user-item preference behavior changes even at an update frequency of hours.

The algorithmic framework of GRACE is generic and can apply to various types of memory systems. Here, consider the use case of a CPU-GPU heterogeneous system and the present GRACE system design. Our system modeling choice is motivated by the fact that this type of system is widely adopted in today's data centers that execute DLRMs.

FIG. 9 depicts a high-level overview of the usage model of the GRACE system. It consists of online profiling of user-item interactions, offline graph construction, clustering, and populating the cache space with partial sums of clusters. GRACE is immediately deployable on commodity hardware platforms.

While running DLRM inference in a data center, GRACE samples a subset of users, and records their item interactions. Specifically, it records which items are accessed together (i.e., pairwise item co-occurrence recording as depicted in FIG. 9) and lazily updates the graph. The lazy nature of graph updates means that the incoming edges to the graph can be buffered and processed at a later point in time. This ensures that the recording phase does not interfere with the performance of the ongoing DLRM inference.

With reference to FIG. 9, GRACE collects the edges recorded during the online profiling phase, and constructs the graph offline. The constructed graph is then clustered to find frequently accessed item combinations. For each cluster, GRACE identifies and fetches the embedding vectors of the constituent nodes, computes psums, and caches embedding vectors and psums into the cache space. GRACE generates clusters in decreasing order of expected cost-benefit efficiency, as shown in Algorithm 1. It then stores clusters of psums in a cache memory (e.g., on the GPU) and then in a non-cache memory (e.g., on a CPU. As shown by prior industrial and academic works, DLRMs employ a remapping table to keep track of cached items. GRACE re-purposes this remapping table to reflect the cached item set. More details on how to filter cached and non-cached accesses, and how to determine the addresses of psums are presented below. Note that the clustering of the graph and computing caching psums does not affect DLRM inference latency as they are carried out offline. Using psums does not change the reduction results; GRACE does not affect DLRM inference accuracy.

As shown in prior works, data center operators typically employ feedback-driven and post-link optimizations to improve the performance of their workloads. In the case of DLRM workload, for example, a data center operator like Meta may profile and record user-item interactions for a week, analyze them offline to create a cache space, and deploy the updated system for inference in subsequent weeks. Several prior works have successfully demonstrated that profile-guided techniques, similar to GRACE, are practical and they are deployed in data centers today.

One of the key goals of GRACE is to achieve a heterogeneous memory-aware framework that also optimizes for high aggregate memory utilization. To compare, MERCI optimizes for a single metric of maximizing the memory traffic reduction. Large clusters formed by MERCI, while yielding a greater bandwidth reduction, prevent most embeddings from being stored in a capacity-limited cache space. In that case, the main memory becomes the throttling bottleneck in processing user requests, and it prevents a high heterogeneous memory utilization.

To combat this, GRACE can be tuned to form appropriately sized clusters to store a greater diversity of item embeddings and combinations to effectively use the cache space. GRACE uses the parameters MAX_CLUSTER_SIZE and tolerance_factor discussed in Algorithm 1 to navigate the complex trade-off space of memory traffic reduction and balance of the heterogeneous memory bandwidth. To be able to apply GRACE to arbitrary input and get the best speedup, GRACE uses a lightweight decision engine to find the best parameter given dataset characteristics. Three features are used from the dataset input: number of items, average pooling factor, and average node degree in the graph to train the decision engine. A decision tree implementation from scikit-learn library and an optimized CART (Classification and Regression Trees) algorithm are used. The decision engine can pick the optimal or near-optimal combination of maximum cluster size and tolerance without exhaustively experimenting with all possible combinations.

As discussed above, GRACE constructs and clusters an ICG, and stores psums into a cache space offline. To efficiently use these psums to improve end-to-end performance, it is crucial to design an efficient cache address computation logic. To this end, a cache data layout and corresponding address generation technique is proposed for efficient GRACE system design. The goal of the designed combined cache data layout and address generation is to compute the address based on the accessed user index at an extremely low cost in software.

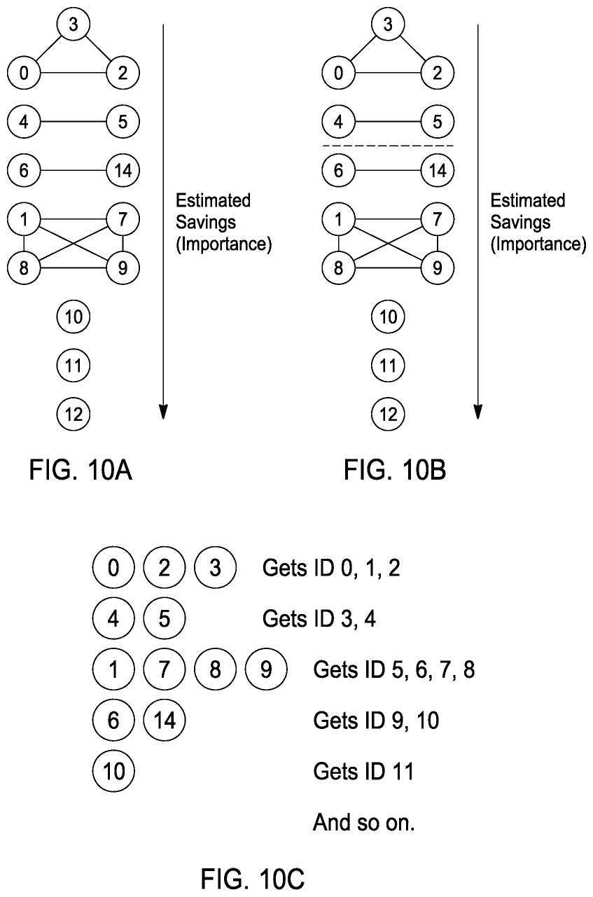

FIGS. 10A-10C further illustrate how the partial sums are stored in memory. For each cluster, a computational benefit is determined, for example during the formation of new clusters as seen in Algorithm 2. The clusters are then ordered according to their computational benefit as shown in FIG. 10A. Given a capacity for the cache memory, a cutoff is determined for clusters stored in the cache memory versus clusters stored in the non-cache memory. With reference to FIG. 10B, assume the cache is size of 12 embeddings. In this example, the first cluster will consume 7 entries, the second cluster will consume 3 entries and the third cluster will consume 3 entries. Because only the first two clusters can fit in the cache memory, the cutoff resides between the second and third clusters. The first and second clusters are stored in the cache memory. As a result, the clusters having the largest computational benefit are stored in cache memory and the remaining clusters are stored in non-cache memory. Lastly, the clusters are reshuffled on each memory device according to decreasing size and unique cluster identifiers are assigned according to the reshuffled order as seen in FIG. 10C.

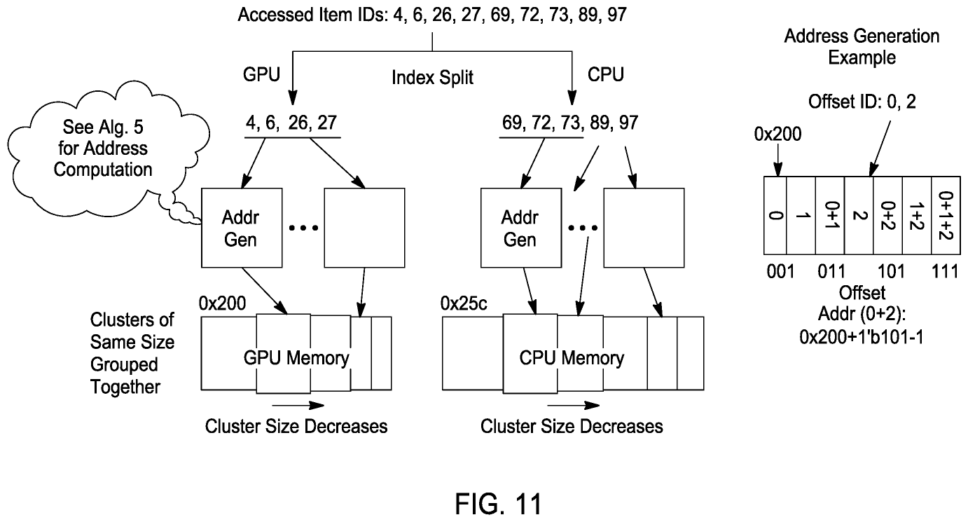

FIG. 11 shows the proposed layout of cached data, where the clusters of the same sizes are grouped together and laid out adjacent to one another in the address space. Notably, GRACE employs a software-managed cache space to avoid hardware additions to commercial hardware platforms. Because software injects cache lines offline, it does not disturb the ongoing inference cycles. To understand cache layout and address generation with a simple example, assume that the largest size cluster is 4 nodes. GRACE first stores all 4-node clusters, then 3-node clusters, and so on. Again, the item IDs are remapped in the order of clusters.

During runtime, the improved memory layout can be used to improve the reduction of partial sums as described in relation to FIG. 5. As a starting point, a list of items is received at 51 from a particular user, where the particular user has shown an interest in each item on the list of items. For each item on the list of items, a unique identifier for the cluster containing the item is determined at 52 using a remapping table. Partial sums for each item on the list of items is then retrieved at 53 from either the cache memory or the non-cache memory. The retrieval mechanism is further described below. Lastly, a reduction for items in the list of items is performed at 54 using the retrieved partial sums.

Given the embedding index of the accessed item, the address generation logic can quickly derive whether the index belongs to the cache memory (i.e., GPU) or the non-cache memory (i.e., CPU). The memory location of the cluster, the cluster size, cluster ID, and offset within the cluster are used to determine specific partial sum addresses (FIG. 11 right). With the above cache layout, the user index only needs to compare with the starting address of each unique length of the cluster group (in practice at most 8 entries) and then compute the address of the embedding vector/partial sum without accessing additional data structures.

Algorithm 5 presents the pseudocode for generating redirected addresses and is set forth below.

1: procedure AddressGen(user_accesses)

| | |
|---|---|
| 2: | Input: user_accesses: Incoming data of item accesses by |
| | runtime users |
| 3: | Input: start_addr: Starting address of each cluster size group |
| 4: | Output: redirected_accesses: Redirected addresses of item |
| | embeddings and partial sums that users request for correct reduction |
| 5: | |
| 6: | prev_c_id = None |
| 7: | prev_g_size = None |
| 8: | temp_addr = None |
| 9: | redirected_accesses = [ ] |
| 10: | for all access ∈ user_accesses do |
| 11: | // Find which group, cluster, and whether CPU/GPU the access |

belongs to

| | |
|---|---|
| 12: | g_size = access.get_g_size( ); |
| 13: | c_id = (access − start_addr[g_size]) / g_size; |
| 14: | item_offset = (access − start_addr[c_id]) % g_size; |
| 15: | // If access has a diff. cluster from prev access, commit prev |

redirected addr

| | |
|---|---|
| 16: | if c_id != prev_c_id or g_size != prev_g_size then |
| 17: | redirected_accesses.append(temp_addr); |
| 18: | temp_addr = start_addr[g_size] + c_id × (2^{g}^{_{—}}^{size} − 1) |
| 19: | temp_addr += (2^{item}^{_{—}}^{offset} − 1) |
| 20: | else |
| 21: | temp_addr +=(2\hat{ }item_offset); |
| 22: | // Accumulate to the redirected addr to get item embeddings / |

partial sums

| | |
|---|---|
| 23: | prev_c_id = cluster; |
| 24: | prev_g_size = g_size; |
| 25: | redirected_accesses.append(temp_addr); |
| 26: | return redirected_accesses |

FIG. 11 presents the end-to-end system execution of GRACE. The partial sums are pinned in the GPU and CPU memory using GRACE software. An example implementation is executed on a heterogeneous GPU/CPU system and uses 1 GB super pages to avoid any paging overhead. GRACE re-purposes the remapping table in software to process the incoming user requests of embedding layers. The remapped and sorted indices split the requests to either CPU or GPU. With a software-defined cache space, the item indices can directly translate into the cluster ID and offset within the cluster. Using Algorithm 5, the redirected addresses are used to correctly serve the requested indices with psums in the heterogeneous memory. The item embedding reduction is then executed on both CPU and GPU simultaneously before the CPU results are sent and reduced with the GPU results. Each batch synchronously reduces item embeddings and computes sparse features on GPUs before processing the top MLP layers. The address generation process of the batch of users is overlapped with the item embedding reduction of the previous batch to ensure that address generation is not on the critical path. The latency of address generation is negligible compared to embedding reduction time.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for processing embedding layers of a model, comprising:
receiving, by a computer processor, a historical data set of items accessed by users of a computer system, where each entry in the historical data set indicates a subset of items accessed by a given user;
constructing, by the computer processor, a graph from the historical data set, where a node in the graph represents a given item, an edge between nodes represents an occurrence of the items being accessed together, and a weight assigned to an edge in the graph indicates a frequency of the items being accessed together;
clustering, by the computer processor, nodes in the graph to form one or more clusters of nodes;
for each cluster in the one or more cluster of nodes, computing partial sums for the nodes assigned to a given cluster; and
storing, by the computer processor, the partial sums in a cache memory.

2. The method of claim 1 wherein clustering nodes in the graph further comprises
a) receiving a maximum value for the cache memory;
b) creating a list of active nodes comprising all of the nodes in the graph;
c) identifying an anchor node from amongst the nodes in the list of active nodes, where the anchor node forms a new cluster and sum of weights for edges connected to the anchor node is largest amongst the nodes in the list of active nodes;
d) creating a new cluster using the anchor node;
e) removing nodes forming the new cluster from the list of active nodes;
f) updating memory space occupied by the one or more clusters with occupied memory space of the new cluster; and
g) repeating steps c)-f) until the memory space occupied by the one or more clusters reaches the maximum value of the cache memory.

3. The method of claim 2 wherein the memory space occupied by the one or more clusters is computed as occupied_space=occupied_space+2^{cluster_size}−1−cluster_size, where cluster_size is the occupied memory space of the new cluster.

4. The method of claim 2 wherein creating a new cluster further comprises
h) creating a set of candidate nodes, where the candidate nodes in the set of candidate nodes are neighboring nodes to nodes in the new cluster;
i) for each candidate node in the set of candidate nodes, estimating a computational benefit of adding a given candidate node to the new cluster to form a candidate cluster;
j) identifying a particular candidate node from the candidate nodes in the set of candidate nodes, where the particular candidate node has largest computational benefit from amongst the candidate nodes in the set of candidate nodes;
k) adding the particular candidate node to the new cluster based on the computational benefit of adding the particular candidate node to the new cluster;
l) removing the particular candidate node from the set of candidate nodes; and
m) repeating steps h)-m) until no viable candidate nodes remain in the set of candidate nodes.

5. The method of claim 4 further comprises adding the particular node to the new cluster in response to the computational benefit of adding the particular candidate node has a value within a tolerance of a computational benefit of the candidate node most recently added to the new cluster.

6. The method of claim 4 wherein estimating a computational benefit of adding a given candidate node to the new cluster further comprises
estimating a maximum benefit of adding a given candidate node to the new cluster by summing weights of edges in the candidate cluster;
estimating a minimum benefit of adding a given candidate node to the new cluster by subtracting weight of edge having lowest value in the candidate cluster from weight of edge having highest value in the candidate cluster; and
setting the computational benefit of adding a given candidate node to a midpoint between the minimum benefit and the maximum benefit.

7. The method of claim 1 wherein computing partial sums for a given cluster in the one or more clusters of nodes further comprises
for each node in the given cluster, retrieving a feature vector corresponding to a particular node from an embedding table of the deep learning recommendation model;
enumerating each unique combination of nodes in the given cluster; and
for each unique combination of nodes in the given cluster, computing partial sums for each feature of the item using the retrieved feature vectors.

8. The method of claim 7 further comprises storing the partial sums in a cache memory by grouping clusters having same size together and laying out the partial sums for each cluster in the one or more clusters adjacent to each other and ordered from clusters having most amount of nodes to clusters having least amount of nodes.

9. The method of claim 1 wherein storing the partial sums further comprises
for each cluster of the one or more clusters, determining a computational benefit for a given cluster;
ordering the one or more clusters according to its computational benefit;
storing clusters from the one or more clusters having largest computational benefit in the cache memory; and
storing remainder of the one or more clusters in a non-cache memory.

10. The method of claim 1 further comprises
receiving a list of items for a particular user, where the particular user has shown an interest in each item on the list of items;
for each item on the list of items, determining a unique identifier for the cluster containing the item using a remapping table;
for each item on the list of items, retrieving partial sums for the item from either the cache memory or the non-cache memory; and
performing a reduction for items in the list of items using the retrieved partial sums.

11. A non-transitory computer-readable medium having computer-executable instructions that, upon execution of the instructions by a processor of a computer, cause the computer to:
receive a historical data set of items accessed by users of a computer system, where each entry in the historical data set indicates a subset of items accessed by a given user;
construct a graph from the historical data set, where a node in the graph represents a given item, an edge between nodes represents an occurrence of the items being accessed together, and a weight assigned to an edge in the graph indicates a frequency of the items being accessed together;
cluster nodes in the graph to form one or more clusters of nodes;
for each cluster in the one or more cluster of nodes, compute partial sums for the nodes assigned to a given cluster; and
store the partial sums in a cache memory.

12. The non-transitory computer-readable medium of claim 11 wherein the computer-executable instructions further cause the computer to
a) receive a maximum value for the cache memory;
b) create a list of active nodes comprising all of the nodes in the graph;
c) identify an anchor node from amongst the nodes in the list of active nodes, where the anchor node forms a new cluster and sum of weights for edges connected to the anchor node is largest amongst the nodes in the list of active nodes;
d) create a new cluster using the anchor node;
e) remove nodes forming the new cluster from the list of active nodes;
f) update memory space occupied by the one or more clusters with occupied memory space of the new cluster; and
g) repeat steps c)-f) until the memory space occupied by the one or more clusters reaches the maximum value of the cache memory.

13. The non-transitory computer-readable medium of claim 12 wherein the computer-executable instructions further cause the computer to
h) create a set of candidate nodes, where the candidate nodes in the set of candidate nodes are neighboring nodes to nodes in the new cluster;
i) for each candidate node in the set of candidate nodes, estimate a computational benefit of adding a given candidate node to the new cluster to form a candidate cluster;
j) identify a particular candidate node from the candidate nodes in the set of candidate nodes, where the particular candidate node has largest computational benefit from amongst the candidate nodes in the set of candidate nodes;
k) add the particular candidate node to the new cluster based on the computational benefit of adding the particular candidate node to the new cluster;
l) removing the particular candidate node from the set of candidate nodes; and
m) repeating steps h)-l) until no viable candidate nodes remain in the set of candidate nodes.

14. The non-transitory computer-readable medium of claim 13 wherein the computer-executable instructions further cause the computer to add the particular node to the new cluster in response to the computational benefit of adding the particular candidate node has a value within a tolerance of a computational benefit of the candidate node most recently added to the new cluster.

15. The non-transitory computer-readable medium of claim 13 wherein estimate a computational benefit of adding a given candidate node to the new cluster further comprises
estimating a maximum benefit of adding a given candidate node to the new cluster by summing weights of edges in the candidate cluster;
estimating a minimum benefit of adding a given candidate node to the new cluster by subtracting weight of edge having lowest value in the candidate cluster from weight of edge having highest value in the candidate cluster; and
setting the computational benefit of adding a given candidate node to a midpoint between the minimum benefit and the maximum benefit.

16. The non-transitory computer-readable medium of claim 11 wherein computing partial sums for a given cluster in the one or more clusters of nodes further comprises for each node in the given cluster, retrieving a feature vector corresponding to a particular node from an embedding table of the deep learning recommendation model;
enumerating each unique combination of nodes in the given cluster; and
for each unique combination of nodes in the given cluster, computing partial sums for each feature of the item using the retrieved feature vectors.

17. The non-transitory computer-readable medium of claim 16 wherein the computer-executable instructions further cause the computer to store the partial sums in a cache memory by grouping clusters having same size together and laying out the partial sums for each cluster in the one or more clusters adjacent to each other and ordered from clusters having most amount of nodes to clusters having least amount of nodes.

18. The non-transitory computer-readable medium of claim 11 wherein the computer-executable instructions further cause the computer to
for each cluster of the one or more clusters, determine a computational benefit for a given cluster;
order the one or more clusters according to its computational benefit;
store clusters from the one or more clusters having largest computational benefit in the cache memory; and
store remainder of the one or more clusters in a non-cache memory.

19. The non-transitory computer-readable medium of claim 11 wherein the computer-executable instructions further cause the computer to
receive a list of items for a particular user, where the particular user has shown an interest in each item on the list of items;
for each item on the list of items, determine a unique identifier for the cluster containing the item using a remapping table;
for each item on the list of items, retrieve partial sums for the item from either the cache memory or the non-cache memory; and
perform a reduction for items in the list of items using the retrieved partial sums.
